(19) United States
(12) Patent Application Publication
(10) Pub. No.: US 2011/0176101 A1
(43) Pub. Date: Jul. 21, 2011

(54) Shapeable Eyewear

(76) Inventor: Timothy Dighton, Ardmore, OK (US)

(21) Appl. No.: 13/007,983

(22) Filed: Jan. 17, 2011

Related U.S. Application Data
(60) Provisional application No. 61/295,754, filed on Jan. 17, 2010.

(51) Int. Cl. G02C 5/06; G02C 5/00

(52) U.S. Cl. 351/126; 351/41

(57) ABSTRACT

This invention relates to eyewear capable of retaining its shape after being manipulated into a new position. This invention also relates to eyewear that is capable of being reshaped to the proper position after manipulation into an undesired position. The invention has independently adaptive components that may be manipulated into multiple positions without undue effort, and will remain in the new position until further manipulation.

This patent application claims priority to U.S. provisional patent application No. 61/295,754 filed Jan. 17, 2010.

### BACKGROUND OF THE INVENTION

This invention relates to eyewear capable of retaining its shape after being manipulated into a new position. This invention also relates to eyewear that is capable of being reshaped to the desired specification of the user after use that results in an undesired position. The invention further relates to eyewear having independently adaptive components that may be manipulated into multiple positions without undue effort, to remain in the new position until further manipulated.

The human head may exist in countless sizes and shapes, making the number of potential configurations that may be desired by the population of eyewear users far greater than those currently provided in the present art of eyewear. Many users of eyewear desire the eyewear to be adaptable to different positions depending on the situation, environment and activities engaged in by the user. Positional adaptability in eyewear has historically concentrated upon the moving pieces of the eyewear: the pads on the bridge of the lens frame and the hinges that connect the lens frame and temple arms. By limiting adaptability to these areas, vast aspects of the human head are left with static positioning that limit the functionality, safety and fashion of eyewear. Unfortunately, past attempts in the arts have failed to develop techniques and devices to craft eyewear that may be shaped into a configuration that is functional, stylish and comfortable.

A common problem with any eyewear is its inherent tension against shaping or re-shaping. Typically eyewear is produced with a plastic-like material that is the most economical for mass manufacturing. However, introducing external stresses to the shape manufactured or molded into the eyewear transfers such stresses to the base structures of eyewear, such as the lens frame, hinges, or temple arms.

Another problem with eyewear that uses hard plastic construction is the inevitable instances of crushing and other traumatic events, resulting in at least two undesirable effects. First, hard plastic pieces may permanently bend or break, rendering the eyewear useless. Second, can also cause the shaping pieces of the eyewear to fatigue, breakdown and otherwise fail.

Some eyewear in the art provides for “return form” flexibility that reduces breakage but only provides for a single position. Such a single position solution may be less desirable to wear due to the creeping fatigue of its working parts. This is especially true with eyewear having shapeable nosepieces and “return form” hinging. In some cases, such eyewear may slip off the face of the user, breaking down eyewear to the point of having to seek professional readjustment to the eyewear or worse, abandonment altogether. In any respect, this approach does not achieve the goal of well-fitting eyewear with little maintenance.

### SUMMARY OF THE INVENTION

In one embodiment, the present invention provides adaptive eyewear with a frame having a lens frame portion, a pliable element, and a flexible portion, the flexible portion adapted to cooperate with the pliable element and retain the eyewear in a desired position, the pliable element communicating with and retaining the flexible portion in a desired position, whereby a user of the eyewear may shape the flexible portion of the frame according to specification. The pliable element may be at least partially located in the flexible portion and have a first end and a second end that may be secured, respectively, in a first lens frame portion and a second lens frame portion.

In another embodiment, the present invention provides an adaptive eyewear with shapeable properties comprising a first lens frame portion and a second lens frame portion to retain a first lens and a second lens about the eyewear, the first and second lens frame portions having a distance between the first and second lens frame portions. The eyewear may further comprise a titanium wire disposed within the flexible portion, the wire having a first end and a second end, the first end being secured in the first lens frame portion and the second end of the wire being secured in the second lens frame portion. The eyewear may further comprise a flexible portion covering at least part of the titanium wire and at least part of the first and second lens frame portions, whereby the titanium wire communicates a selected positional change to the flexible portion and holds lens frame portions in a configuration selected by user of eyewear.

Numerous objects and advantages of the invention will become apparent as the following detailed description of the preferred embodiments is read in conjunction with the drawings which illustrate such embodiments.

### BRIEF DESCRIPTION OF THE DRAWINGS

FIG. 1 depicts a side raised perspective view of the shapeable eyewear.

FIG. 2 depicts a top plan view of the eyewear.

FIG. 3 depicts a front view of the eyewear.

FIG. 4 depicts a back view of the flexible portion and pliable element, revealing the interior of an inventive aspect of the eyewear.

FIG. 5 depicts a front view of the eyewear, depicting an axis of movement.

FIG. 6 depicts a side view of the eyewear, depicting an embodiment of eyewear.

FIG. 7 depicts a top plan view of the eyewear, depicting axes of movement of the shapeable eyewear.

### DETAILED DESCRIPTION OF THE PREFERRED EMBODIMENTS

The present invention achieves a number of objects and presents advantages over the prior art. Eyewear is provided that retains its shape when manipulated into a new position. Additionally, the inventive eyewear is pliable without relying on external or exposed moving parts to gain positioning advantage for the eyewear. The present invention further provides a solution may be implemented that reduce the stresses of upon the other structures of the eyewear.

The present invention resolves the problem of one-size-fits-all eyewear that inevitably fails to fit much of the population of users. It presents the advantage of versatility in use, so that those utilizing the present invention may select different configurations of the eyewear depending on the activity engaged by the user. The present invention provides for shapeable eyewear that is functionally and comfortable to the face of a user, who may select the degree of space between the eyewear and his or her head. The present invention avoids problematic breakage of eyewear and fatigue due to worn moving parts. It furthermore reduces the instances of abandonment due to eyewear that no longer fits due to fatigue due to worn moving parts.

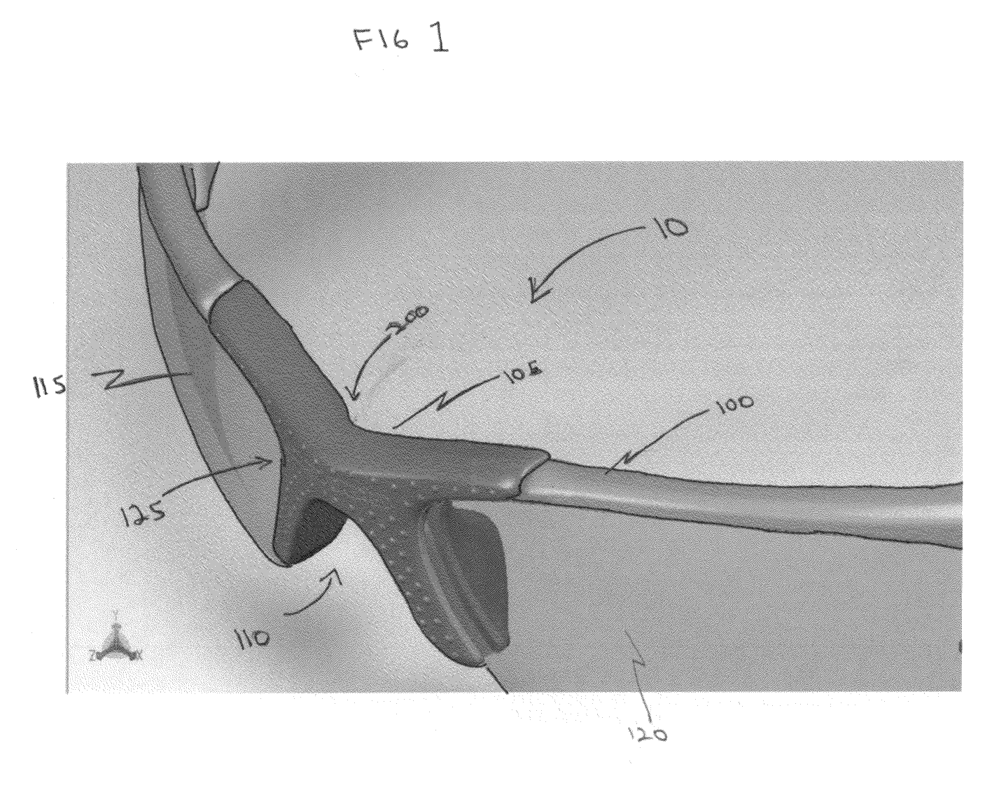

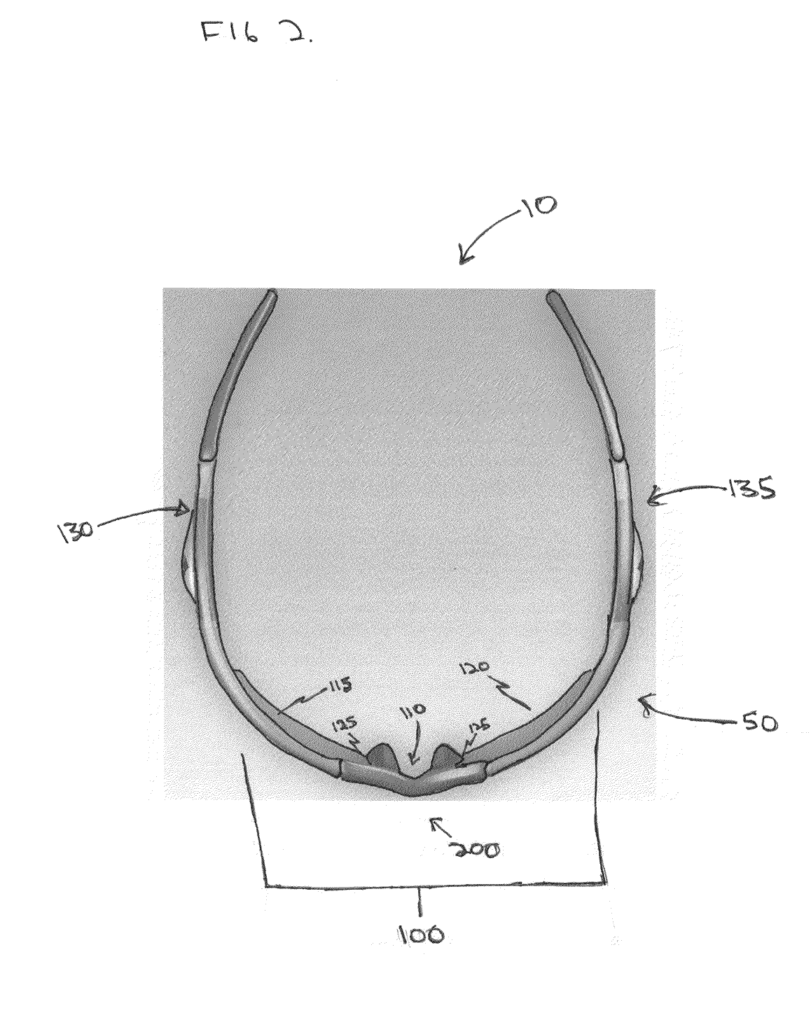

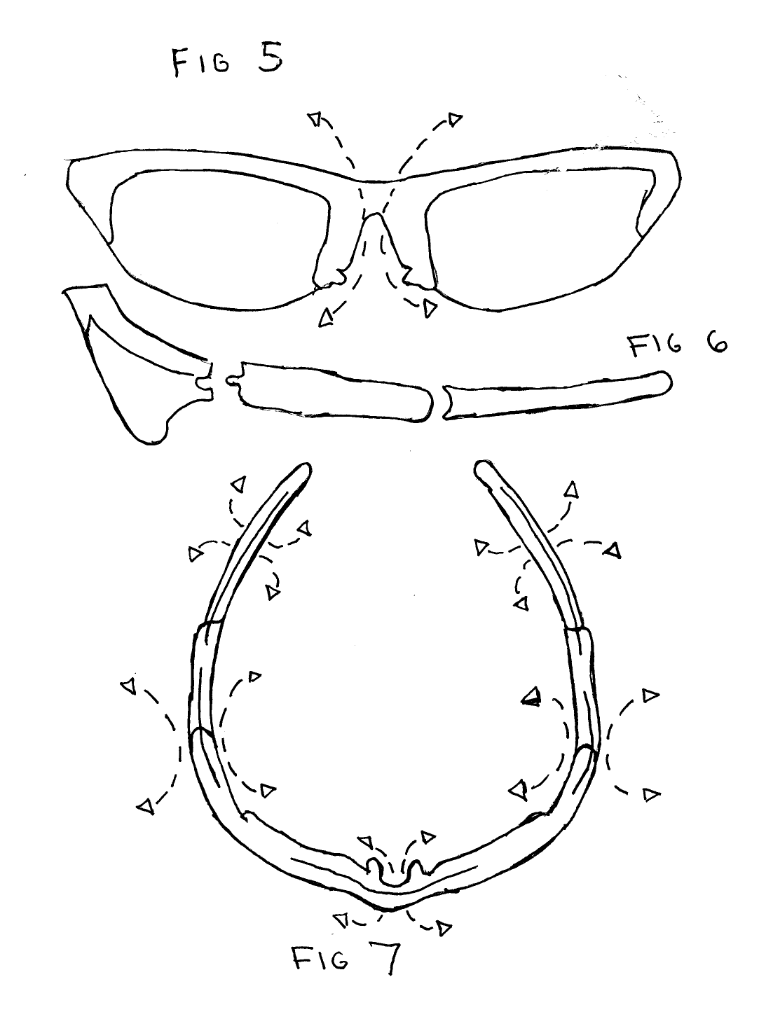

FIGS. 1-7 depict embodiments of shapeable eyewear. While other types of eyewear may be used with the present invention, the selected illustrations depict an application as performance eyewear or sunglasses.

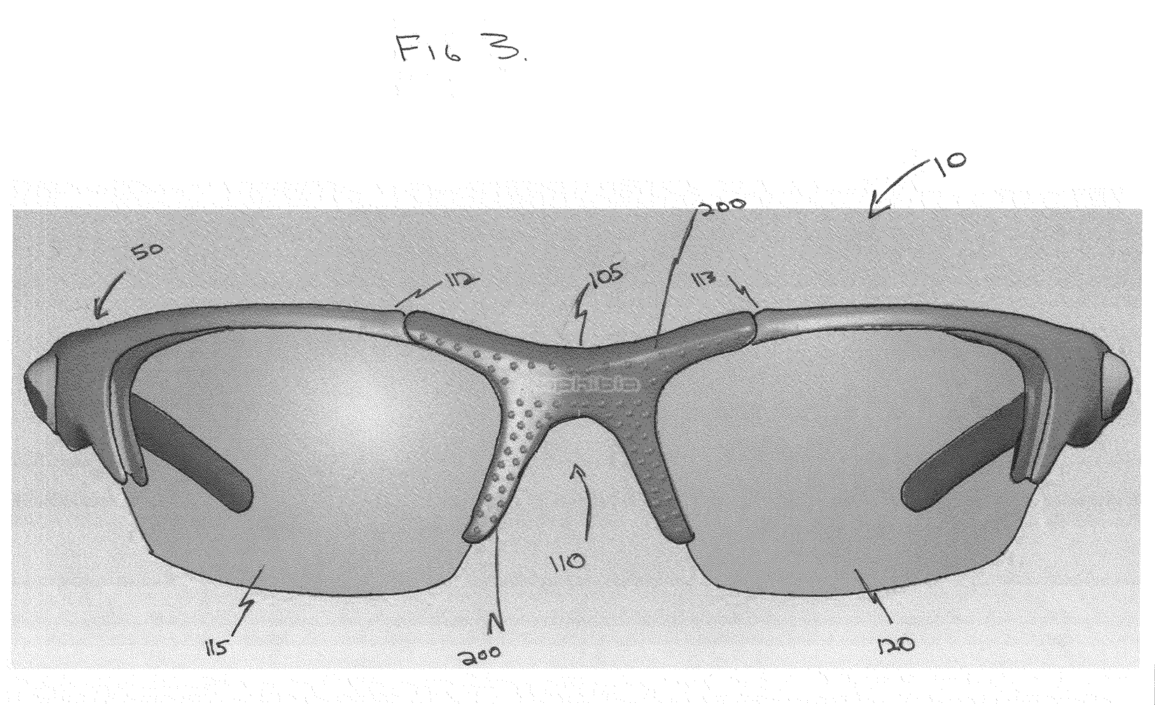

Adaptive eyewear 10 may have a frame 50 to generally carry the various structures of eyewear known in the art, in addition to those embodied in the present invention. Seen in FIG. 3, frame 50 may comprise a lens frame portion 100, the lens frame portion 100 being associated with a first lens 115 and a second lens 120 of adaptive eyewear 10. Lens frame portion 100 may have a first lens portion 102, center area 105 and a second lens portion 103. In an embodiment seen in FIG. 4, lens frame portion in not an integral piece but may have a gap at the center area 105. Lens frame portion is constructed of a hard plastic, metal and/or textile material. A best mode of the invention uses the material known in the arts as TR-90. First lens 115 and second lens 120 may have bridge boundaries 125, the boundaries 125 being associated with a central area 105 of lens frame portion 100 that is sometimes referred to in the eyewear arts as a bridge.

In a preferred embodiment seen in FIG. 1, lens frame portion 100 may have a bridge structure 110. Bridge structure 110 may at least partially include the lens frame portion 100 of frame 50 that bridges or spans between the first lens 115 and second lens 120, though structure 110 may not necessarily be confined to the central area 125 of the lens frame portion 100. In a preferred embodiment, the lens frame portion may have a first bridge ridge 112 and a second bridge ridge 113 located on either side of the central area 105 of the lens frame portion 100. Bridge structure may further include a flexible material 200 and a pliable element 150, as described below.

Frame 50 may have first 130 and second 135 temple portions. Temple portions may be considered as the portions of the inventive frame 50 that a user of adaptive eyewear 10 may position in relation to the temple and side of the user's head. In some cases, temple portions 130, 135 rest upon ears of the user.

Eyewear 10 may include the flexible portion 200. In one embodiment, flexible portion 200 is constructed as a layer that at least partially overlays the lens frame portion 100. In another variation, flexible portion 200 is preferably a highly resilient material which permits multiple flexures without breaking. Preferably, flexible portion 200 comprises a silicone rubber. Preferably, flexible portion 200 is comprised of the aforementioned silicone rubber or other materials generally known in the arts to provide similar function.

Eyewear 10 may further comprise a pliable element 150. Pliable element 150 may be formed out of a material that provides for manipulation into a desired position, and retain that desired position for an indefinite period of time. In a preferred embodiment, pliable element 150 may be a titanium wire and may be formed in a variety of shapes or sizes, includes a closed loop, a straight line, and a linear segment having at least one arcuate aspect. In a preferred embodiment, pliable element 150 is located at least partially within flexible portion 200. Pliable element 150 may have a first end 155 and a second end 160. In preferred embodiments, the first end 155 of pliable element 150 may be secured to a first bridge ridge 112 and the second end 160 may be secured to a second bridge ridge 113 of the lens frame portion 100.

In preferred embodiments pliable element 150 communicates with the flexible portion 200. Pliable element 150 may do so in a number of ways. In one embodiment, Pliable element 150 is disposed within a channel 180 of the flexible portion 200 and has some movement within channel 180. Channel 180 may be located either side of flexible portion 200 or enclosed therein. Alternatively, pliable element 150 may be molded into, or sandwiched within flexible portion 200. In yet another embodiment, pliable element 150 need not directly abut flexible portion 200 to communicate and to influence its position. In practice, flexible element 200 provides benefits to users of adaptive eyewear 10 by providing shapeable flexibility when communicating with pliable element 150 to provide an increased ease of selecting a position, comfort to the user and stability of the frame 50 upon the user's head.

Flexible portion 200 may be formed using many different methods. For example, one suitable method utilizes an injection mold process to form flexible portion 200. Pliable element 150 may be placed in the mold prior to the molding process. Alternatively, channel 180 may be molded into flexible frame, and pliable element 150 may be inserted after the fact. Together, the flexible portion 200 and the pliable element 150 may be alternatively referred to as shapeable flexibility.

In preferred embodiments where pliable element 150 is secured within the frame 50 of eyewear 10, pliable element 150 may be manufactured into the molding of frame 50.

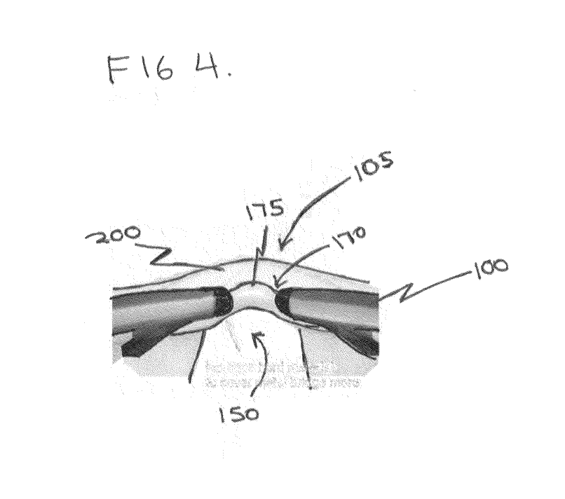

According to other embodiments of the invention as seen in FIG. 5, flexible portion 200 and pliable element 150 may be provided in locations of eyewear 10 outside of bridge structure 110. In one embodiment, areas of shapeable flexibility that include flexible portion 200 and pliable element 150 may be located at an intersection 140 of first and second temple portions 130, 135 and the lens frame portion 100. In another, shapeable flexibility may be added at a point further towards an end of the temple portions 130, 135, to engage the area behind a user's ear.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. An adaptive eyewear comprising
a frame having a lens frame portion, a pliable element, and a flexible portion, the flexible portion adapted to cooperate with the pliable element and retain the eyewear in a desired position, the pliable element communicating with and retaining the flexible portion in a desired position, whereby a user of the eyewear may shape the flexible portion of the frame according to specification.

2. The eyewear of claim 1, wherein the pliable element is at least partially located within the flexible portion of the frame.

3. The eyewear of claim 2, the pliable element having a first end and a second end.

4. The eyewear of claim 3, lens portion having a first lens frame structure and a second lens frame structure, whereby a first lens frame structure retains a first lens and the second lens frame structure retains the second lens.

5. The eyewear of claim 4, the first lens retaining structure retaining a first end of the pliable element and the second lens retaining a second end of the pliable element.

6. The eyewear of claim 1, wherein the pliable element is a wire.

7. The eyewear of claim 6, the wire having at least one arcuate aspect with an arcuate apex, the arcuate apex disposed distal to the user of eyewear.

8. The adaptive eyewear of claim 1, the frame having a first and second temple portions.

9. The adaptive eyewear bill of claim 1, wherein the flexible portion of the frame is formed by being injection molded with the pliable element incorporated therein.

10. An adaptive eyewear with shapeable properties comprising:
A first lens frame portion and a second lens frame portion to retain a first lens and a second lens about the eyewear, the first and second lens frame portions having a distance between the first and second lens frame portions,
A titanium wire disposed within the flexible portion, the wire having a first end and a second end, the first end being secured in the first lens frame portion and the second end of the wire being secured in the second lens frame portion,
A flexible portion covering at least part of the titanium wire and at least part of the first and second lens frame portions, whereby the titanium wire communicates a selected positional change to the flexible portion and holds lens frame portions in a resulting configuration.
